(19) United States
(12) Patent Application Publication
(10) Pub. No.: US 2009/0118852 A1
(43) Pub. Date: May 7, 2009

(54) Virtual manufacturing of transmission elements

(75) Inventors: Kaushik Kumar, Ranchi (IN); Sanat Kumar Mukherjee, Ranchi (IN); Goutam Pohit, Kolkata (IN)

Correspondence Address: VENABLE LLP, P.O. BOX 34385, WASHINGTON, DC, 20043-9998, US

(73) Assignee: BIRLA INSTITUTE OF TECHNOLOGY, Ranchi (IN)

(21) Appl. No.: 12/000,061

(22) Filed: Dec. 7, 2007

(30) Foreign Application Priority Data
Nov. 2, 2007 (IN) 1518/KOL/07

(51) Int. Cl. G06F 17/00; G06G 7/64

(52) U.S. Cl. 700/98

(57) ABSTRACT

A software structure which when adapted in an apparatus is capable of virtual manufacturing of transmission elements for example gear means with chip formation, the software structure comprising a start module for loading the source file in a main editor-file that contains the computer program, an input module for providing input parameters that are essential for the configuration of a product and a cutting tool, a product design module for evolving the parameters for the manufacturing of the product; and a virtual manufacturing module having at least three sub-modules one each for tool generation, visualisation of machining operation, and disassembly of the product from the machine bed.

### FIELD OF THE INVENTION

The present invention relates to virtual manufacturing of transmission elements for example, gears. More particularly, the present invention relates to a software structure that enables virtual manufacturing of transmission elements for example, gears, with chip formation.

### BACKGROUND OF INVENTION

Manufacturing of the transmission elements seems to be fairly complicated event to the person having thorough technical knowledge in the related field. The conventional generation processes of transmission elements for example, a gear comprising for example, forming, shaping, hobbing etc. are usually represented in two-dimensional sketches. However, it may be difficult to understand the complex geometries and the manufacturing arrangement with the help of 2D models. Though this limitation can be partially overcome using 3D solid model instead, the development of the models using 3D solids may not always ensure the clarity of the complex generation process of transmission elements, unless one uses animation to represent the motion of the blank and the cutter. This can be achieved very efficiently with the help of Virtual Manufacturing technique.

The growing developments in virtual reality (VR) systems have created a growing potential for applications of VR and the associated technologies. VR involves immersion of the subject in a computer-generated environment that looks and feels real. It is a technology to create virtual environment on the computer screen to simulate the physical world. The knowledge base and expertise gained from the work in the virtual environment enables the user to apply then more meaningfully in the real life situation.

During any manufacturing process chip formation and chip breaking mechanism have been found to be a focus of attention for many years. Starting with the Merchant chip formation model in 1945, many researchers have contributed to the understanding of this area. The results of past studies [1, 2] were based on simple cutting tools which have the same tool geometry and cutting parameters along the cutting edge. There has been less research on complicated cutting tools, whose geometry and cutting parameters differ along the cutting edge. The present invention attempts to simulate manufacturing process of transmission elements providing special emphasis on the chip formation involved during any cutting operation.

A host of literature is available on Virtual Manufacturing in different areas among which some of the recent and important works are referred below. Tesic and Banerjee have worked in the area of rapid prototyping using Virtual Reality technologies, distillation and auto interpretation. Balyliss et. al used the virtual reality technologies in order to provide an outstanding 3D visualization of the object. Later G. M. Balyliss et. al presented theoretic solid modeling techniques using the VM tools, like VRML (Virtual Reality Manufacturing Language) and 3D-STUDIO MAX. They have used their technique to represent various components used in automobile industry. Kimera has further enhanced the work by representing product and process modeling as al kernel for virtual manufacturing environment. In his work, Kimura has addressed significant modeling issues like representation, representation language, abstraction, standardization, configuration control, etc. Arangarasan and Gadh used the platform of MAYA and VRML to simulate planned production process. At Jadavpur University and Birla Institute of Technology research work is being carried out to simulate the gear manufacturing processes using AUTOCAD and 3D Studio Max as the platform.

A study of the state of the art and literature review reveal that the scope of virtual manufacturing is wide open even for generation processes of transmission elements for example, spur gear. Computer simulation can be very effectively used to view and subsequent analysis of different complicated manufacturing processes using the concept of design centered virtual manufacturing.

### OBJECTS OF THE INVENTION

It is therefore an object of the invention to propose a software structure that enables virtual manufacture of transmission elements for example, gears, with chip formation.

Another object of the invention to propose a software structure that enables virtual manufacture of transmission elements for example, a spur gear, which includes simulation of chip formation during the step of gear forming.

A still another object of the invention is to propose a software structure that enables virtual manufacture of transmission elements for example, a spur gear, which can be implemented on a 3D-STUDIO-MAX platform by adapting virtual tools.

A further object of the invention is to propose an apparatus capable of adopting the software structure of the invention for virtual manufacture of transmission elements.

### SUMMARY OF THE INVENTION

While the apparatus and the software structure of the invention is applicable for virtual manufacture of various transmission elements, for the sake of practical demonstration of the invention, a process of gear cutting has been described in the text. However, the present invention is not limited to virtual manufacturing of gears only.

There are various methods of gear cutting. Each of these methods has a field of application to which it is best adapted. The type of gear being manufactured usually dictates the selection of the process. Since one of the objective is to simulate the phenomenon of chip formation, gear milling process has been chosen as the operating environment using conventional up milling. Both spur and helical gears are generated in virtual reality. According to the invention, the procedure followed for virtual manufacturing of a transmission element for example, a gear, can be summarized as under:

Spur Gear Generation

A disc type form cutter has been used for the purpose. Usually a milling machine is designed for the same. Here the cutting cycle is made completely automatic, including fast return of the tool and indexing of the blank until all the teeth are generated. In this process a form cutter passes through the gear blank to remove the material forming the tooth gap. Adjusting the axis of the gear blank and axis of cutter introduce the requisite depth of cut appropriately.

The desired depth of cut is achieved in number of cuts as specified by the user in the input data. After the completion of one tooth of the gear, the blank rotates and the cycle repeats. The process continues till all the teeth are generated. An attempt has been made to incorporate all the features mentioned above so as to make the software realistic and user friendly.

Helical Gear Generation

A disc form cutter has been used for the purpose. If cutting plane of the cutter is inclined to the vertical plane a helical gear is generated. The same method has been used with a variation; instead of inclining the teeth of the cutter, the cutter as a whole is inclined. Unlike the case of spur gear, the cutting movement of the cutter is not along the radial direction of the blank but it is inclined by the angle equal to the helix angle as specified by the user. The cutter has only rotational motion while other movements are imparted on the blank.

Chip Formation

In the present invention, the step of chip formation is simulated. Chip Formation during gear cutting is a fairly complicated phenomenon involving several factors mentioned below.
1. Type of chip
2. Path of chip movement
3. Curling of chip, and
4. Chip contraction

In order to clarify the process of chip formation, characteristics of each factor are mentioned below in brief.

Type of Chip

The material of the gear dictates the type of chip being generated. They can be segmented, continuous, continuous with built up edge or inhomogeneous chip.
1. The segmental chip are formed by a fracture mechanism when brittle materials are cut at low cutting speeds.
2. The continuous chips are formed without a built-up edge on the tool. This type of chips is formed during cutting of ductile materials under steady-state conditions.
3. The continuous with built up edge (BUE) are generated under low cutting speeds where the frictions between the chip and the rake face of the tool is resulting high temperature and subsequent weldment of the chip to the tool face. This accumulation of chip material is known as built-up edge.
4. The inhomogeneous chips are obtained during cutting operation of hardened and stainless steels and titanium alloys at high cutting speeds. They are macroscopically continuous chips consisting of narrow band of heavily deformed material alternating with larger regions of relatively undeformed material.

Path of Chip Movement

The basic mechanism by which chips are formed during the gear cutting is that of the deformation of the material lying in front of the cutting edge because of the shearing action. The movement of the chip formed is along a defined path,

Where Vc is the Chip velocity,
V is the cutting speed,
θ is Chip movement angle,
φ is shear angle,
ψ is Rack angle,
t₂ is chip width

The software module has been designed in such a manner that the chip movement will be along a spline. The spline has been created by using the equation:

θ=−(π/2−γ)

During the operation of gear cutting three chips are formed for each tooth of the cutter. Two are flank chips and one is bottom chip. In the simulation, it is assumed that chips are being generated independently without interfering with one another.

Curling of Chip

As the layer becomes thicker and acquires a wedge shape as a result of which curvature (curling) is produced. The principal factors influencing chip curling are cutting angle, thickness of the uncut chip (rate of feed), cutting speed, cutting fluid etc. Depending upon the machining conditions, the chip can curl into a flat (logarithmic) spiral or into a helix. Flat spirals are formed in case

φ=90° and γ=0.

In the machining of gears φ≠90° and γ±0 hence the chip will curl into a helix.

Due to plastic compression of the layer of metal being cut, the chip turns out to be shorter than the part of the blank it has been cut, i.e. L₀>L. This shortening is known as longitudinal shortening and is characterized by coefficient of contraction or cutting ratio (k) where k=L₀/L

The value of k, in general, lies between 6 and 8.

Hence the invention depicts the chip formation using the above mentioned spline equation under the following assumptions:
1. The type of chip formed is considered to be continuous with built up edge (BUE) as the gear material is generally ductile and the cutting speed is also low
2. The chip width is taken to be equal to the width of cut
3. The thickness is assumed to be constant throughout, and
4. The value of contraction ratio, k is assumed to be 7

### BRIEF DESCRIPTION OF THE ACCOMPANYING DRAWINGS

FIG. 1(a)—schematically shows the movement of the gear blank and the cutter during the cutting process according to the invention.

FIG. 1(b)—shows the rotational movement of the cutter, the other movement being imparted on the blank.

FIG. 2(a)—shows the chip formation during the cutting process

FIG. 2(b)—shows the defined path of chip movement during the cutting process.

FIG. 2(c)—show the flank chips and the bottom chip during the cutting process

FIG. 2(d)—shows the formation of curling during the chip formation.

FIG. 2(e)—shows the chip contraction due to plastic compression of the metal layer being cut during the cutting process.

FIG. 3—shows the various frames during the process of spur gear cutting, generated which on simulation produces the dynamic behaviour of the process.

FIG. 4—shows the top and side views of the final product of FIG. 3 including the chip formation during cutting process.

FIG. 5—shows the simulated frames in case of helical gear cutting

FIG. 6—shows the final product and chip formation during helical gear cutting process.

FIG. 7—shows the software support system implemented according to the invention.

FIG. 8—shows a sample input dialogue window

FIG. 9(a)—shows a typical material sheet

FIG. 9(b)—shows a typical Modified panel's parameters rollout for the camera

FIGS. 9(c) & 9(d)—shows a sample lighting parameters that fetch good views of the cutting process

FIG. 9(e)—shows selection of frame rate in animation during the during the cutting process

FIG. 9(f)—a typical dialogue box to manipulate the rendering step.

### DETAIL DESCRIPTION OF THE INVENTION

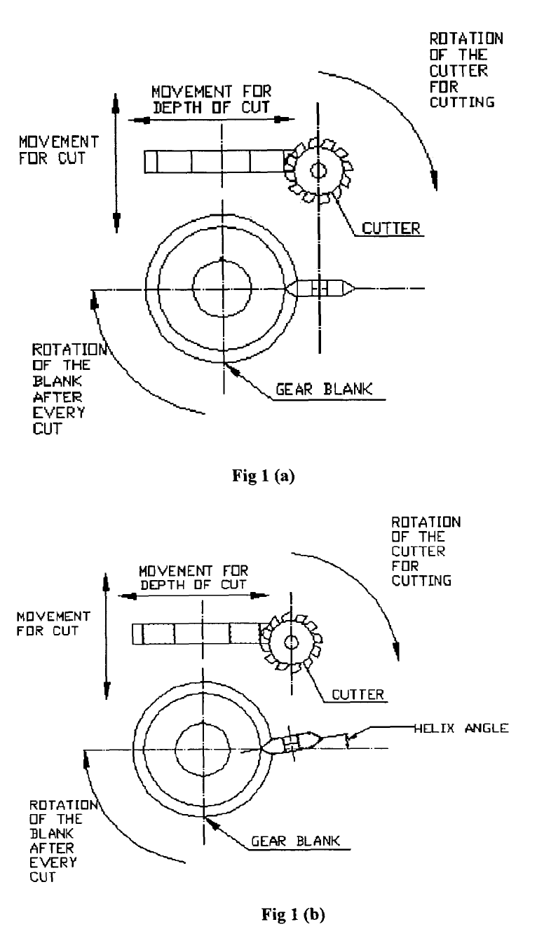

As shown in FIG. 1(a), a disc type form cutter in a milling machine is designed including indexing of the job (blank). The figure shows the movement of the tool during formation of the teeth in a spur gear. FIG. 1(b) shows the rotational movement of the tool in a helical gear generation in which other movement is imparted on the job (blank). During the virtual manufacturing process, chip formation is a novel phenomenon in the innovative cutting process of the invention in order to achieve the effect of chip formation several characteristic for example, type of chip, path of chip movement, curling of chip, and chip construction are taken into consideration.

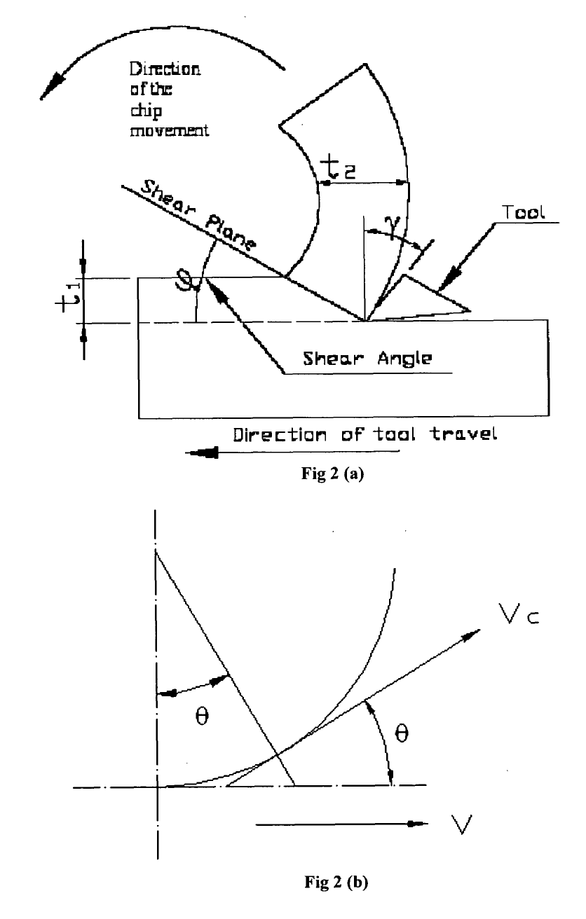

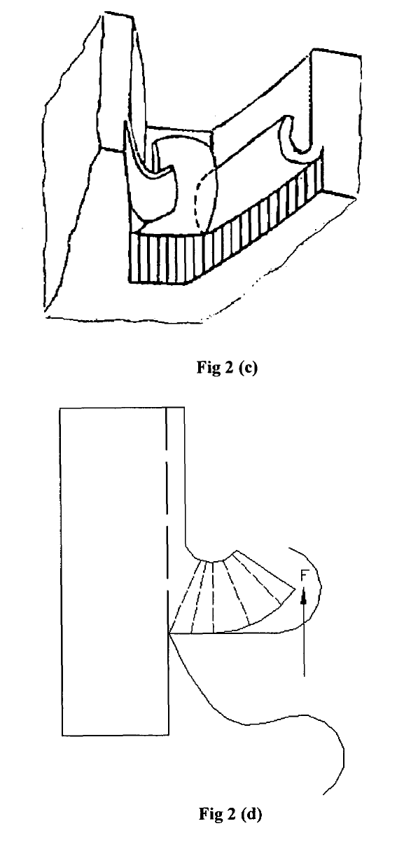

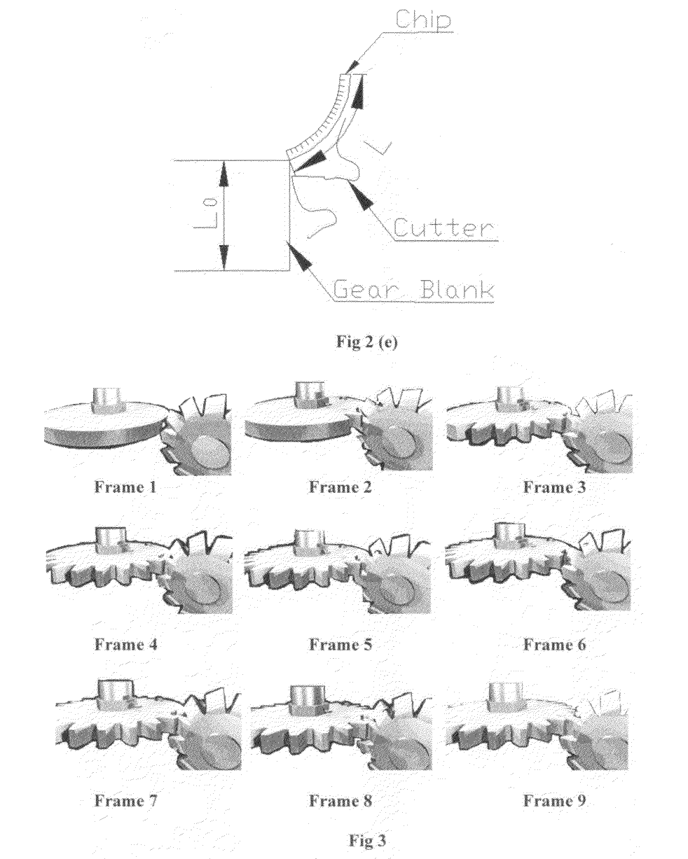

FIG. 2(a) shows the generation of chip during the cutting process. According to the invention, the path of chip movement has been defined along a spline which has been shown in FIG. 2(b). The spline has been created by adapting a relationship of, θ=−(π/2−γ), where Vc is the chip velocity, v is the cutting speed, θ is chip movement angle, φ is shear angle, ψ is Rack angle, t₁ is width of cut, and t₂ is chip width. The type of chip formed during the cutting has been discussed hereinabove which generally relates to type of material cut, the tool designed, and rotational speed of the tool including the job (blank) movement. FIG. 2(c) shows the type of chips for example, flank chips and bottom chip generating during gear-cutting.

FIG. 2(d) shows the ‘curling of chips’ which depends on cutting angle, rate of feed, cutting speed, cutting material, and cutting fluid used. The curling can be in a logarithmic spiral, or a helix shape.

FIG. 2(e) shows the phenomenon of ‘chip construction’, which can be described as ‘shortening’ which results due to plastic compression of the layer of metal which is cut. Accordingly, the chip turns out to be shorter than the part of blank cut.

The present invention can be implemented in a general-purpose computer apparatus having an operating system with hardwares like storage devices in the form of Read only memory (ROM), and random access memory (RAM) a display device interfaced with the processor, several input devices for example keyboard, mouse. The invention can also be implemented in a special-purpose computer with appropriate hardwares capable of running and operating the software of the invention.

The software module is written in such a way that the user is guided, with the help of user friendly screens, stepwise from creation of the gear, cutter and the various input parameters to the final output in form of Frames or a movie clip. In the final output the user not only visualizes the gradual forming of gear tooth but also gets a realistic view of chip formation and dispersion. This makes the output close to actual machining in a milling machine. The entire system is developed in modular form. They are: start module; Input Module; Optional Module and Virtual Manufacturing Module. A brief description of each of these modules is mentioned below.

(a) Start Module

This module loads the source-file in the main editor-file that contains all the programs developed in MAX—Script language using a particular code. When 3D-STUDIO MAD is accessed the interface and is displayed at first, it does not contain all the tool bars. Hence it is required to customize the interface so that all the tool bars are loaded. It is advisable to open and load through the file menu of the Max-Script listener which is one of the most important display unit of 3D-STUDIO MAX. When an attempt is made to evaluate a max-script program file, the processing and the outcome are displayed at each level of execution of the program and flash an error message to the user.

(b) Input Module

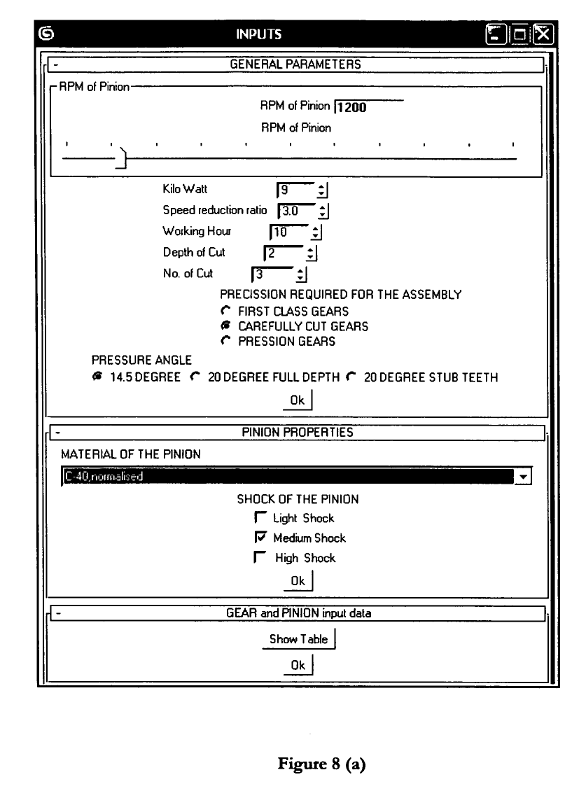

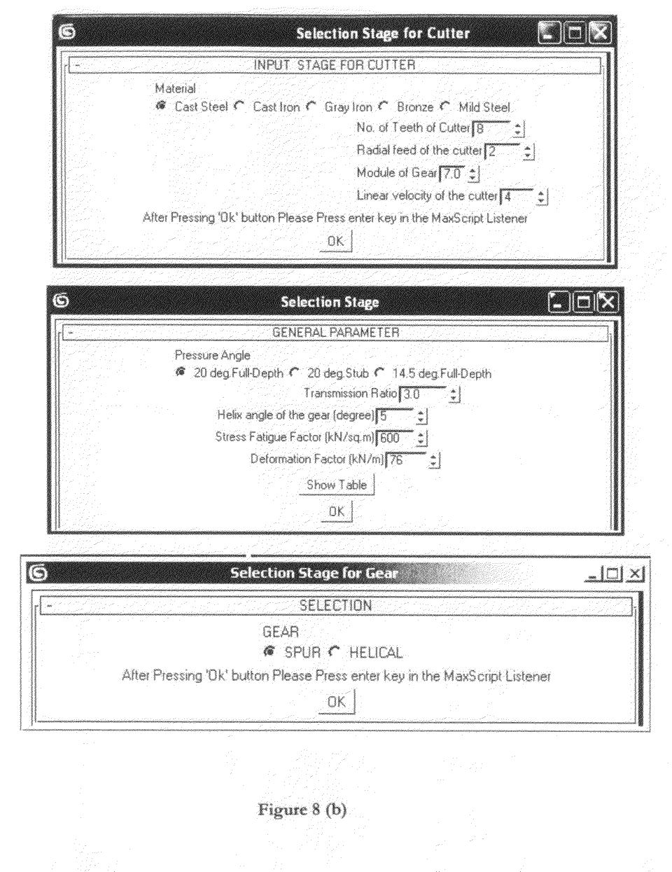

The various design parameters are evaluated first and data are entered through the input dialogue window specially created by max script language has to be filled in. The various parameters have been assigned with a predefined upper and lower limit to make the module more user friendly. If the user gives any erroneous data the module would start giving warning message and would not proceed further till all the dta are properly filled up and none of the compulsory parameters omitted. A sample input dialogue windows are shown in FIG. 8.

In order to manufacture a gear the user is required to provide certain essential parameters e.g.
1. Speed of the gear
2. Module of gear
3. Transmitted power
4. Transmission ratio
5. Pressure angle
6. Material of construction of the gear and cutter
7. Helix angle in case of the helical gear
8. Left handed or right handed gear

There are certain optional data, for example the depth of cut, the number of cut, precision of the gear etc. Each parameter requires some predetermined value which the user must enter before proceeding further. Moreover if the user wants to modify any one or more parameters, the program can be recalled and the changes can be made resulting automatic up gradation of the product. This practice is almost impossible in an actual machine and thus saves time and cost.

(c) Optional Module

In order to provide a realistic view of the gear cutting operations, a few optional modules have been introduced. They are named as material, camera, light, animation and render. The scope of each optional module is mentioned below:

Material

Colour is probably the simplest material property and the easiest to identify. Within the Material Editor, there are several different colour swatches or effects that control different aspects of the object's colour. The following list describes the types of colour swatches that are available for simple materials:

Ambient: Defines an overall background lighting that effects all objects in the scene, including the colour of the object when it is in the shadows. This colour can be locked to the diffuse colour so that they are changed together.

Diffuse: The surface colour of the object surface in normal full light. The normal colour of an object is typically defined by its Diffuse colour.

Specular: The colour of the highlights where the light is focused on the surface of a shiny material.

Self-illumination: The colour that the object glows from within. This colour takes over any shadows on the object.

Filter: The transmitted colour caused by light shining through a transparent object.

Reflect: The colour reflected by a ray trace material to other objects in the scene.

Luminosity: Caused an object to glow with the defined colour. It is similar to Self-Illumination colour but can be independent of the diffuse colour.

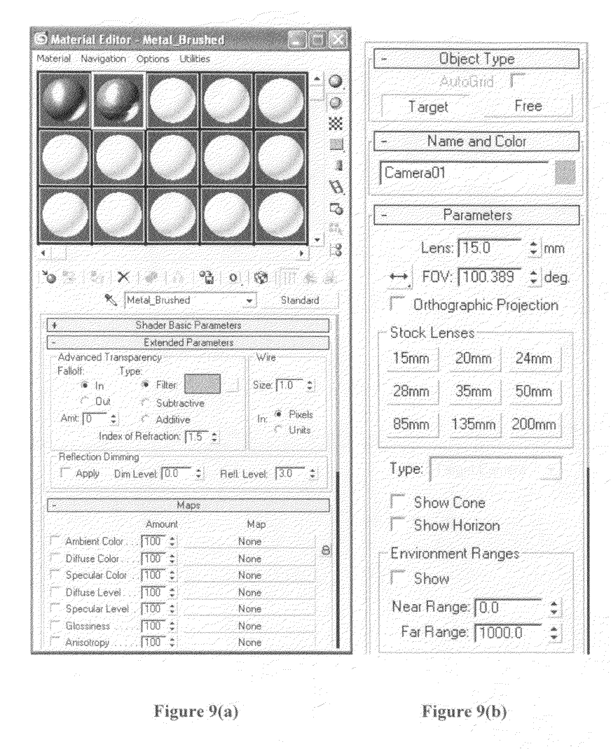

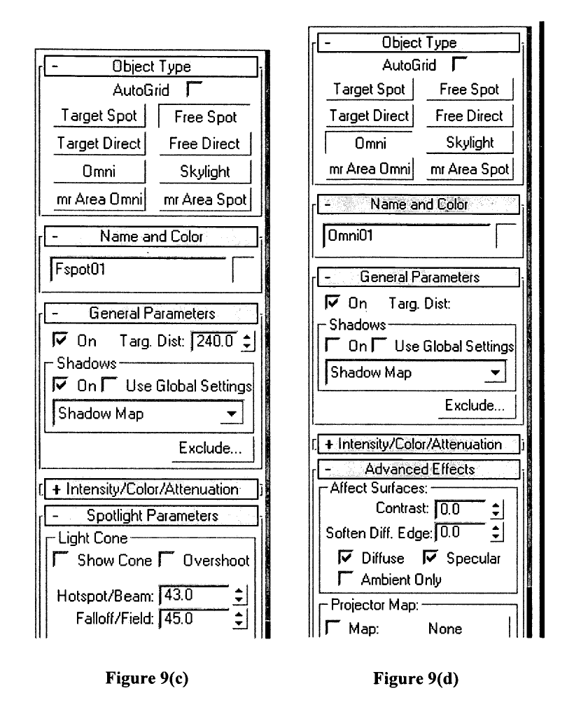

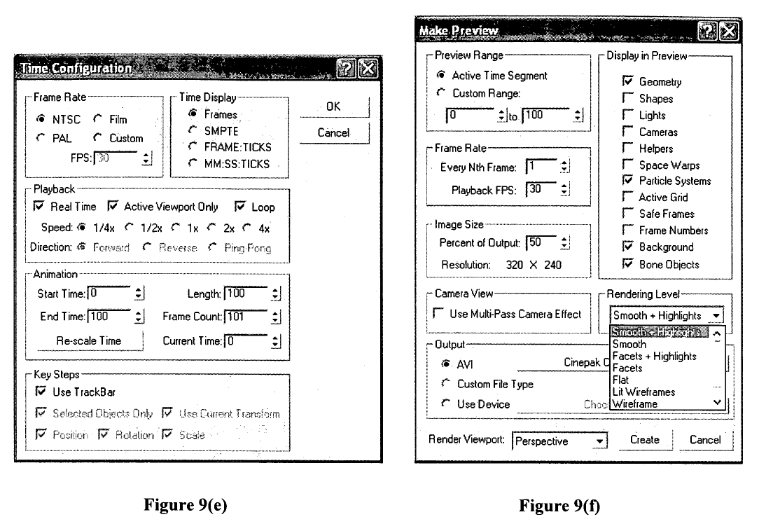

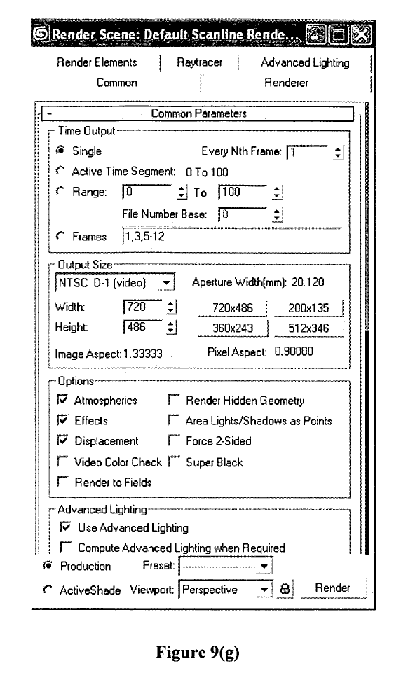

Opacity and transparency: Opaque objects are objects that cannot see through, such as metals. Transparent objects, on the other hand, are objects that can be seen through, like glass. The software materials include several controls for adjusting these properties, including Opacity and several Transparency controls. Opacity is the amount that an object refuses to allow light to pass through it. An object with 100 percent opacity is completely transparent, and an object with opacity of 100 percent doesn't let any light through. Transparency is the amount of light that is allowed to pass through an object. Because this is the opposite of opacity, transparency can be defined by the opacity value. Several options enables the user to control transparency, including Falloff, Amount, and Type. A typical material sheet is shown in FIG. 9(a).

Reflection and refraction: Shiny objects like polished gear reflect their surroundings. Refraction is the bending of light as it moves through a transparent material. The amount of refraction that a material produces is expressed as a valve called the Index of Refraction. The Index of Refraction is the amount that light bends as it goes through a transparent object. The default Index of Refraction value is 1.0 for objects that don't bend light at all. By defining a material's reflection values, the user can control how much reflection is required for his setup. A gear, for example, reflects the images of chips, but a chip won't reflect at all.

Camera

There are two types of cameras that the user can create namely a Free camera and a Target camera. Camera objects are visible as icons in the screen, but they aren't rendered. The camera icon looks like a box with a smaller box in front of it, which represents the lens or front end of the camera. Both the Free and Target camera types can include a cone that shows where the camera is pointing.

Free Camera

The Free camera object offers a view of the area that is directly in front of the camera and is the better choice if the camera will be animated. The single parameter for Free cameras defines a Target Distance—the distance to an invisible target about which the camera can orbit.

Target Camera

A Target camera always points at a controllable target point some distance in front of the camera. Target cameras are easy to aim and are useful for situations where the camera won't move. The user can make modifications in the camera position and property. A typical modified panel's parameters rollout for the camera is shown in FIG. 9(b).

Light

Lighting plays a critical part of any virtual manufacturing process. Understanding the basics of lighting can make a big difference in the overall virtual perspect of the rendered scenes. The software has an option of using two types of lighting: natural light or artificial light. When lighting a scene, not relying on a single light is best. The software includes one key light and several secondary lights. A spotlight has been used for the main key light. It is positioned in front of and slightly above the gear cutter arrangement, and it casts shadows, because it is the main shadow-casing light in the scene. The secondary lights fill in the lighting gaps and holes. The position of these are at floor level on either side of the gear and cutter, with the intensity set at considerably less than the key light and set to cast no shadows. FIGS. 9(c) and 9(d) show a sample lightening parameters that are generally played to fetch a good view of the cutting process.

Animation

The user can set several options including the Frame Rate. Frame rate provides the connection between the number of Frames and time. It is measured in Frame per second. The options include standard Frame rates including NTSC (National Television Standards Committee, around 30 Frames per second), Film (around 24 Frames per second), and PAL (Phase Alternate Line, used by European countries around 25 Frames per second), or user can decide on the Frame rate based on his choice as shown in FIG. 9(e).

The Time Display section allows to set time on the Time Slider. The options include Frames, SMPTE (Society of Motion Picture Technical Engineers), Frame: Ticks or MM:SS:Ticks (Minute and Seconds) SMPTE is a standard time measurement used in video and television. A Tick is 1/4800 of a second.

Render

Render is the doorway to the final output. Here the user can manipulate the rendering operation using the following dialog box. A typical dialogue box looks like FIG. 9(f).

The Render Scene dialog box includes options the output options such as which Frames to render and the final image size can be specified.

The Environment dialog box includes options the environment settings such as a background colour or image, global lighting settings, and atmospheric effects such as Combustion, Fog, and Volume Lights can be adjusted.

The Rendering Effects dialog box includes options such as Lens Effects, Blur, and Colour Balance.

The Advanced Lighting control panel where the settings for the Light Tracer, Radiosity, Exposure Control, and Lighting Analysis tools are located.

(d) Virtual Manufacturing Module

Virtual manufacturing gives life to already created stationary objects using the input module discussed earlier. In other words, it simulates the dynamic behaviour of gear cutting which is created as a series of still pictures. The still pictures, known as Frames (FIGS. 3, 4, 5, 6) are first generated with a little change of position of the gear blank and cutter from the previous one. When these Frames are displayed in proper sequence at successive interval, they create the impression of gear cutting, blank movement, cutter movement etc. For creating a proper illusion of animation, as discussed in the special module, developer must have thorough understanding of the max-script programming environment of 3D Studio Max. The animated output is stored in the hard disc and can be played using suitable media player.

A few important features of the software module are highlighted below.

The up and down motion with simultaneous forward movement of the gear blank and the rotating cutter creates the impression of cutting of a tooth on the blank. A large number of such Frames are generated by the software to depict the different stages of material removal from the gear blank to the final finish. The upward motion of the blank corresponds to the cutting stroke, the downward motion represents the idle stroke while positioning of the cutter under the blank illustrates the depth of cut.

A few important frames are shown in FIGS. 3-6. The Frame 1, as shown in FIG. 3 illustrates the beginning of the operation and the next Frame (Frame 2) shows the position at the end of the cutting action of the tooth. Such successive Frames illustrate the disengagement of the cutter, withdrawal of the blank, indexing, and positioning of the blank by rotation to its next place, reengagement of the cutter when the cutting of the next tooth begins. When all these Frames are shown one after another in their sequential order, the observer gets the impression of virtual manufacturing of the gear.

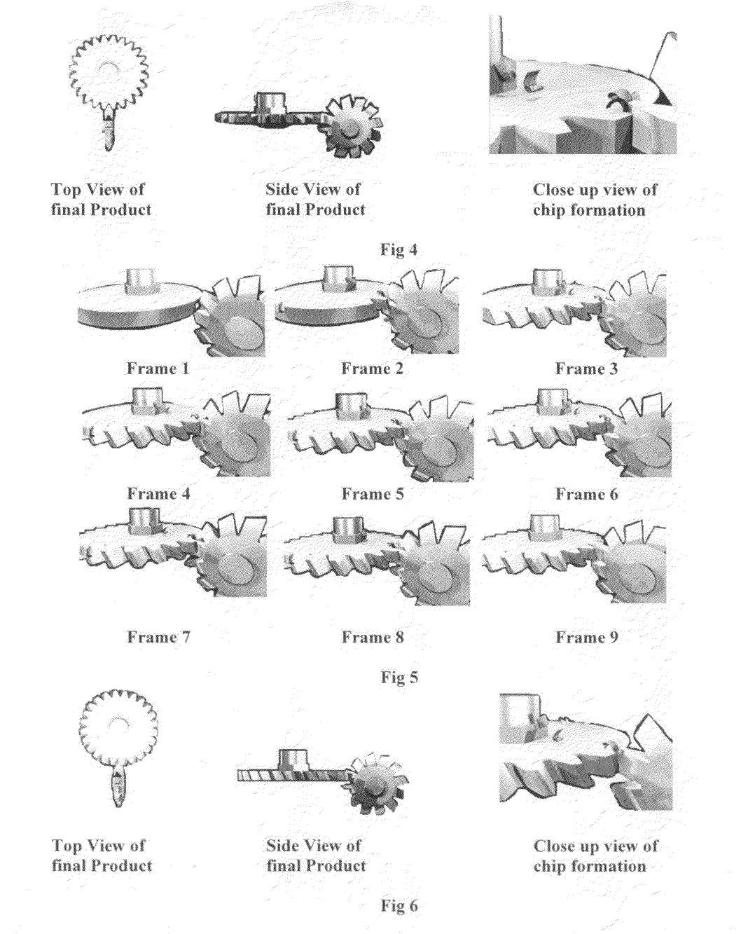

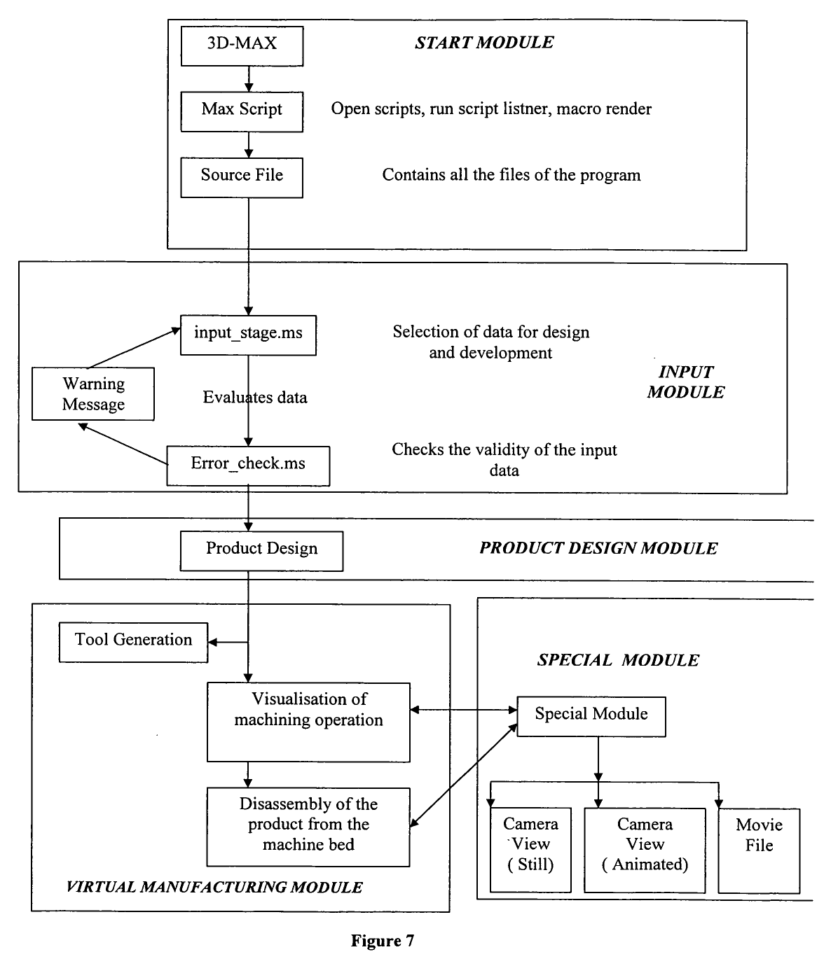

FIG. 4 exhibits a close up view of the chip formation during the cutting operation of the gear blank. The similar method is followed to simulate the cutting operation of helical gear as well. A few selected Frames are shown in FIGS. 5 and 6. The software module further provides movie files where the Frames can be moved with a projection rate suitable to give a clear demonstration of the virtual manufacturing process. In a movie it is not possible to change the viewing direction and the target position. In the present invention user can select either of them (or both) as per his choice and hence can have better understanding of the operational principle of gear cutting by form tools.

The invention has the advantage of creating movie files in which a user can control projection of Frame rates. The slow motion projection is very helpful for demonstration purpose as well.

The present invention provides the entire procedure of gear manufacture using a form cutter in a virtual environment. The software support structure is developed in a modular form to accommodate additional features of gear generation without disturbing the original software. In addition it includes the aspect of chip formation during gear cutting operation making it more realistic. The apparatus has the capacity to create movie files for a better understanding of a, otherwise, complex manufacturing process capturing the phenomenon of chip formation as well. The invention automatically disables the insertion of inadequate data by giving a warning message and indicating the necessary corrective measures.

The invention also helps the user to have a clear preconception of the actual gear that will be manufactured on the given data. The user can also change the design to suit the requirement, by changing the relevant parameters. The invention can be a very efficient learning aid for those who want to have proper understanding of gear manufacturing operation by form tool.

1. A software structure which when adapted in an apparatus is capable of virtual manufacturing of transmission elements for example gear means with chip formation, the software structure comprising:
a start module for loading the source file in a main editor-file that contains the computer program;
an input module for providing input parameters that are essential for the configuration of a product and a cutting tool;
a product design module for evolving the parameters for the manufacturing of the product; and
a virtual manufacturing module having at least three sub-modules one each for tool generation, visualisation of machining operation, and disassembly of the product from the machine bed.

2. The software structure as claimed in claim 1, wherein the input module is enabled to check the validity of the input data and further check the default data.

3. The software structure as claimed in claim 1, wherein the tool-generation sub-module creates a solid model of the tool with all the cutting geometry for example, major cutting angles including a clearance angle in respect of the cutter, and wherein the solid tool is enabled to animate in the virtual environment during the cutting process.

4. The software structure as claimed in claim 1, wherein the visualisation of machining operation sub-module is adapted to generate the product.

5. The software structure as claimed in claim 1, wherein the disassembly sub-module is enabled to simulate the activities of dismantling the job from the worktable in a virtual environment.

6. The software structure as claimed in claim 1, which when loaded and operated in an apparatus enables performing the following method steps:
designing a cutting machine preferably a milling machine;
forming a blank to be configured with gear teeth;
forming a cutting tool, preferably disc type cutter adaptable to the milling machine;
inputting desired data in respect of speed of the gear, module of the gear, transmitted power, transmission ratio, pressure angle, material of construction of the gear and the cutter, and helix angle in case of helical gear;
activating parameters of optional modules such as material, camera, light, animation, and render;
inputting data relating to a predefined path for chip movement; and
activitating the automatic cutting operation of the transmission element with the input of data respecting rotational speed of the cutter, angle of cut, blank rotation, rotational angle of the cutter, depth of cut, and number.

7. The software structure as claimed in claim 6, wherein said predefined path for chips movement is selected based on the relationship of θ=−(π/2−γ), wherein Vc=chip velocity, v=cutting speed, θ=chip movement angle, φ=shear angle, ψ=Rack angle, t₁=width of cut, and t₂=chip width.

8. A computer apparatus for virtual manufacturing of transmission elements for example, gears comprising a general purpose computer interfaced with input devices and a display device; and a software support structure as claimed in claim 1.

9. The software structure as claimed in claim 3, wherein the visualisation of machining operation sub-module is adapted to generate the product.

10. The software structure as claimed in claim 1, wherein the disassembly sub-module is enabled to simulate the activities of dismantling the job from the worktable in a virtual environment.

11. A computer apparatus for virtual manufacturing of transmission elements for example, gears comprising a general purpose computer interfaced with input devices and a display device; and a software support structure as claimed in claim 7.
